(19) United States
(12) Patent Application Publication
(10) Pub. No.: US 2025/0092343 A1
(43) Pub. Date: Mar. 20, 2025

(54) ALCOHOL REMOVAL BY DILUTION AND CONCENTRATION OF ALCOHOLIC SOLUTIONS

(71) Applicant: PORIFERA, INC., SAN LEANDRO, CA (US)

(72) Inventors: CHARLES BENTON, Berkley, CA (US); OLGICA BAKAJIN, SAN LEANDRO, CA (US)

(73) Assignee: PORIFERA, INC., SAN LEANDRO, CA (US)

(21) Appl. No.: 18/729,235

(22) PCT Filed: Jan. 25, 2023
(86) PCT No.: PCT/US2023/061299

§ 371 Date: Jul. 16, 2024

Related U.S. Application Data
(60) Provisional application No. 63/302,711, filed on Jan. 25, 2022.

(51) Int. Cl. C12H 3/04

(52) U.S. Cl. CPC C12H 3/04

(57) ABSTRACT

Embodiments described herein relate to systems and methods for removing alcohol from alcoholic solutions using forward osmosis, dilution, and concentration, where the dilution and concentration with forward osmosis is used after an initial concentration stage performed using forward osmosis.

### CROSS-REFERENCE TO RELATED APPLICATIONS

This application claims priority to U.S. Provisional Application No. 63/302,711 filed on 25 Jan. 2022, the disclosure of which is incorporated herein in its entirety by this reference.

### BACKGROUND

Consumers enjoy alcoholic beverages, but some consumers do not want to have alcohol or would like reduced alcohol in their beverages. For example, expectant mothers, religious abstainers, people struggling with alcohol addiction, people with medical conditions, or other people may not want alcohol in their beverages but may want to enjoy the flavor of the beverages.

Removing alcohol from alcoholic beverages often negatively affects the flavor of the alcoholic beverage. It is difficult to prevent volatile organic compounds and some dissolved components from exiting the beverage when temperature manipulation such as heating or freezing is utilized to remove alcohol. Further, removing nearly all of the alcohol form an alcoholic beverage can be energy intensive and costly.

### SUMMARY

Examples described herein relate to systems and methods for removing alcohol from alcoholic solutions using dilution and concentration.

In an embodiment, a method for removing alcohol from a beverage is disclosed. The method includes performing a plurality of forward osmosis processes on an alcoholic beverage to remove alcohol therefrom effective to form a product with a lower alcohol content than the alcoholic beverage, wherein each of the plurality of forward osmosis processes removes water and at least some alcohol from the alcoholic beverage and at least one of the plurality of forward osmosis processes after an initial forward osmosis process includes adding water to the alcoholic beverage prior to the at least one of the plurality of forward osmosis processes. The method includes outputting the product as a final product

In an embodiment, a system for removing alcohol from alcoholic solutions is disclosed. The system includes a first forward osmosis stage configured to receive an alcoholic solution having a concentrated feed stream output and a diluted draw stream output. The system includes a water input operably coupled to the concentrated feed stream output to add water thereto to form a first diluted feed stream. The system includes at least a second forward osmosis stage operably coupled to the first forward osmosis stage to receive the first diluted feed stream and output a product having an alcohol concentration that is less than an alcohol concentration of the alcoholic solution.

In an embodiment, a method for removing alcohol from a beverage is disclosed. The method incudes performing a first forward osmosis process on an alcoholic beverage to remove water and alcohol therefrom to form a first product with a lower alcohol content than the alcoholic beverage. The method incudes adding water to the first product to form a first diluted beverage having a lower alcohol content than the alcoholic beverage. The method incudes performing a second forward osmosis process on the first diluted beverage to remove water and alcohol therefrom to form a second product with a lower alcohol content than the first product. The method incudes adding water to the second product to form a second diluted beverage having a lower alcohol content than the first product.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

For better understanding, the like elements have been designated by like reference numbers throughout the various accompanying figures. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a block diagram of a system for removing alcohol from an alcoholic solutions using forward osmosis, according to an embodiment.

FIG. 2 is a flow diagram of a system for removing alcohol from an alcoholic solution using forward osmosis, according to an embodiment.

FIG. 3 is a block diagram of a system for removing alcohol from an alcoholic solution via forward osmosis, according to an embodiment

FIG. 4 is a block diagram of a system for removing alcohol from alcoholic solutions using forward osmosis, according to an embodiment.

FIG. 5 is a block diagram of a system for concentrating alcoholic solutions using forward osmosis, according to an embodiment.

FIG. 6 is a flow diagram of a method for removing alcohol from an alcoholic solution, according to an embodiment.

FIG. 7 is a flow diagram of a method for removing alcohol from an alcoholic beverage, according to an embodiment.

### DETAILED DESCRIPTION

Embodiments described herein relate to systems and methods for removing alcohol from alcoholic solutions using forward osmosis (FO) to concentrate the solution and then adding water into the concentrated solution prior to or during subsequent FO stages (e.g., processes or module(s)) to remove more alcohol from the concentrated solution. The systems and methods described herein remove alcohol from alcoholic solutions (e.g., beverages such as wine, hard cider, or beer) utilizing FO systems having discrete stages containing one or more FO modules utilizing FO membranes. The FO modules contain one or more FO membranes separating a feed side from a draw side of the system. The systems and methods utilize multiple FO stages to remove both water and alcohol from the alcoholic solution.

The FO stages are configured in series, and may be broken into at least two groups. The first group of FO stages is used to concentrate the alcoholic solution to a higher concentration, for example 2×-6× or 3×-4× the initial concentration. This first group of FO stages may include one to three stages, where each stage is responsible for a portion of the concentration process. During this first FO process, alcohol is largely not rejected by the FO membrane, for example alcohol has a rejection of less than 2%, thus alcohol and water will transport across the FO membrane at approximately the same concentration they exist in the starting alcoholic solution, resulting in the alcohol concentration in the solution remaining constant as the solution is concentrated. Other components of the alcoholic solution, including sugars, polysaccharides, acids, minerals and organic compounds, are well rejected (“well rejected components”), for example at a rejection greater than 98%, and are retained and concentrated in the alcoholic solution.

The second group of FO stages is used for adding water and using forward osmosis to further remove water and alcohol of the alcoholic solution at a constant concentration of well rejected components, for example 2×-6× or 3×-4× the initial concentration, while the alcohol concentration is reduced. This second group of stages may include one to five stages, where each stage is responsible for a portion of the dilution and concentration process In the dilution and concentration process, water and alcohol is removed from the alcoholic solution as they permeate through the FO membrane as in the previous concentration process. However, as the alcohol and water is removed it is replaced by water equaling the substantially the same volume, the concentration of the well rejected components of the alcoholic solution remain constant, while the concentration of the alcohol is continuously reduced. The dilution and concentration is performed to allow for alcohol removal in addition to the concentration while preventing the alcoholic solution from becoming over concentrated resulting in precipitation or formation of solids that would otherwise remain in solution. Accordingly, the dilution and concentration processes and systems disclosed herein prevents membrane fouling, system fouling, and loss of efficiency as components are removed from the concentrated feed stream. Dilution and concentration additionally keeps the osmotic pressure of the concentrated alcoholic solution low enough that it can be dewatered using a reasonable draw solution, for example 28 wt % glycerin and water.

It should be noted that if a lower amount of alcohol removal is needed, for example from an alcoholic solution having at least 12% alcohol by volume (“ABV”), such as only 75% removal, only the first process (or group of stages) is needed and the dilution and concentration step(s) can be skipped. However, in order to substantially completely dealcoholize alcoholic solutions (e.g., make a beverage with 0.5% ABV or less or even 0.05% ABV or less) dilution and concentration is utilized. Such dilution and concentration aids in meeting non-alcoholic standards in various jurisdictions.

Once the desired alcohol removal has been attained in either the first or second group of stages, the concentrated and dealcoholized solution is discharged by the system. Water may be added at this point to dilute the solution, for example back to the initial concentration of well rejected components.

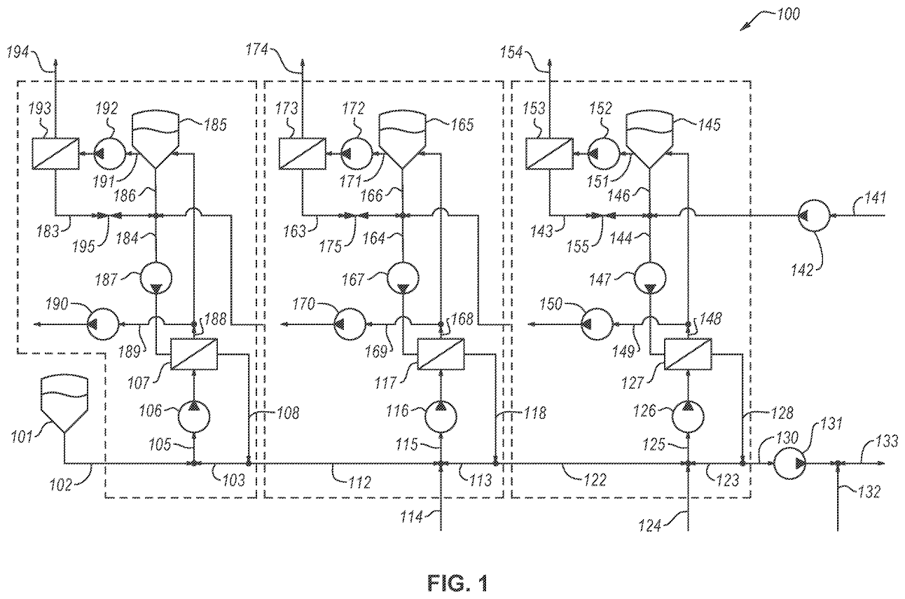

FIG. 1 is a block diagram of a system 100 for removing alcohol from alcoholic solutions using forward osmosis, according to an embodiment. The system 100 includes a plurality of FO stages 107, 117, and 127. Each of the FO stages 107, 117, and 127 includes one or more FO modules including a fluid tight container having a feed side and a draw side separated by an FO membrane capable of allowing alcohol (e.g., ethanol) and water to pass therethrough and to prevent sugars, polysaccharides, acids, minerals, and organic compounds (e.g., greater than 100 AMUs) from passing therethrough. For example, the FO membrane may include a hydrophilic support layer and a polyamide rejection layer in a thin film composite membrane, such as any of the FO membranes disclosed in U.S. Pat. No. 8,920,654 issued on Dec. 30, 2014, the disclosure of which is incorporated herein in its entirety by this reference. At least some of the FO stages or modules herein may include a plurality of FO membrane elements arranged in series therein, where an FO element includes a discrete amount of FO membrane surface area separating a draw side and a feed side. Suitable FO membrane elements and modules may include any of the FO membrane elements or modules disclosed in U.S. Pat. No. 9,636,635 issued on May 2, 2017. the disclosure of which is incorporated herein in its entirety by this reference. Each FO stage 107, 117, or 127 may include one or an array of FO modules arranged in series, such as three FO modules each having seven membrane elements therein, all arranged in series where the draw sides are fluidly connected and the feed sides are fluidly connected between the modules in series. While the above well rejected components are substantially completely rejected, it should be understood that trace amounts of well rejected components (e.g., less than 1% or less than 0.5%) may permeate the membrane or through holes therein. Each FO stage (e.g., alcohol removal stage) may be utilized with a selected draw stream to remove a selected amount of alcohol from a feed stream, which may differ between FO stages. The system 100 includes water injection streams 114 and 124 to add water into the feed streams that have been concentrated in the FO stages.

The feed side of an FO stage (and modules therein) includes a feed side inlet for receiving a feed stream and a concentrated feed stream output (e.g., outlet) for outputting the concentrated feed stream. The draw side of an FO stage (and modules therein includes a draw stream inlet and a diluted draw stream output (e.g., outlet) for outputting the diluted draw stream. The inlets and outputs of the feed side and draw side may be arranged in a countercurrent flow (draw stream flows in opposite direction as the feed stream) or a co-current flow configuration. Countercurrent flow configurations provide a relatively steady osmotic pressure and flux across a length of the FO membrane.

As a feed stream is sequentially circulated through the FO stages 107, 117, and 127, the water content of the feed streams are lowered via FO. However, the osmotic potential of the feed stream is increased thereby retarding the removal of alcohol. In order to facilitate the FO, water removed from the feed stream in each FO stage is added back into the concentrated feed stream via water injection streams 114 and 124.

The system 100 includes a feed source 101 (e.g., tank or constant pressure slip stream) containing an alcoholic solution or beverage. For example, the feed source 101 may include a supply of beer, wine, hard cider, spirits, or the like. The feed source 101 may include an essence, such as a perfume. The feed source may include any other alcohol containing solution. Feed source 101 is fluidly connected to a first FO stage 107, such as via a one or more conduits (e.g., pipes, hoses, valves) to form feed stream 102. The feed stream may be pressurized by one or more pumps 106. Feed stream 102 enters the first FO stage (e.g., alcohol removal stage). Stream 102 may be connected to a recirculated solution stream 103, to mix with a partially concentrated and recirculated solution to form a feed stream 105. In some examples, the stream 105 may not include the recirculated solution stream 103. Stream 105 may be coupled to and pressurized by a pump 106. Stream 105 is coupled to the feed side of the first FO stage 107. Feed stream 105 enters the feed side of the first FO stage 107, where water and alcohol is removed, then exiting as concentrated feed stream 108 after being concentrated. Concentrated feed stream 108 may then be split into recirculated feed stream 103 and concentrated feed stream 112, such as at a valve or slip stream.

The concentrated feed stream 112 may be passed to the second FO stage (e.g., second alcohol removal stage) via a conduit. The concentrated feed stream 112 is operably coupled to, and mixed with, a water injection stream 114 forming to form a diluted solution stream 115. The concentrated feed stream 112 may also be operably coupled to, and mixed with, a partially concentrated and recirculated beverage stream 113 to form the diluted solution stream 115 (e.g., at least partially reconstituted beverage having a lower alcohol content than feed stream 102). Stream 115 is connected to and pressurized by a pump 116, such as to 20 psi (138 kPa). Stream 115 is connected to and enters the feed side of the second FO stage 117, where water and alcohol is removed to form a second concentrated feed stream 118 after being concentrated.

The water injection stream 114 may be supplied by a water source that includes water from wine (“WFW”), water from grape juice, or water recovered and recirculated from the draw side of an FO stage 107, 117, or 127. The water injection stream 114 may provide a volumetric flow rate that is equal to the volumetric flow rate of the water and alcohol removed in the second FO stage 117 as to prevent the further concentration of the alcoholic solution as alcohol is removed therefrom. The second concentrated feed stream 118 may then be split into second recirculated feed stream 113 and second concentrated feed stream 122 such as at a valve or slip stream.

The second concentrated feed stream 122 is fluidly connected to the third FO stage 127 (e.g., third alcohol removal stage). Stream 122 is connected to and mixed with a water injection stream 124 to form a diluted feed stream 125. Stream 122 may be connected to and mixed with a partially concentrated and recirculated feed stream 123 to form diluted feed stream 125. Stream 125 may be connected to and pressurized by a pump 126, such as to 20 psi (138 kPa). The diluted feed stream 125 enters the feed side of the third FO stage 127, where water and alcohol is removed, the stream then exiting as third concentrated feed stream 128 after being concentrated (third concentrated feed stream).

The water injection stream 124 may be supplied by a water source that includes WFW or water recovered and recirculated from the draw side of an FO stage 107, 117, or 127. The water injection stream 124 may provide a volumetric flow rate that is equal to the volumetric flow rate of the water in the second FO stage 117 to prevent the further concentration of the alcoholic solution as alcohol is removed therefrom. The third concentrated feed stream 128 may then be split into third recirculated feed stream 123 and third concentrated feed stream 130 such as at a valve or slip stream. The third concentrated feed stream 128 and 130 is a fully concentrated and dealcoholized stream and may be metered out of the third FO stage (e.g., alcohol removal stage), such as with a metering pump 131 operably coupled thereto, to control the flow rate of stream 130.

The third concentrated feed stream may be operably coupled to, and rehydrated by, water injection stream 132. The water injection stream 132 may be supplied by a water source that includes WFW or water recovered and recirculated from the draw side of an FO stage 107, 117, or 127. The water injection stream 132 may provide a volumetric flow rate that is equal to the volumetric flow rate of the water removed in the third FO stage 127 as to prevent the further concentration of the alcoholic solution as alcohol is removed therefrom. The addition of water from water injection stream 132 forms a rehydrated, or partially rehydrated, dealcoholized stream 133 as a product of the system 100.

The above components constitute a feed side of the system 100. The system 100 includes a draw side on the draw side of the FO stages 107, 117, and 127.

The draw side of the FO system (e.g., interconnected draw side of FO modules) includes a draw stream source which supplies a draw solution to the FO stages. The draw solution includes a solution having a higher osmotic pressure (and lower osmotic potential) than the feed solution. For example, the draw solution may include a higher total concentration of permeable and/or impermeable solutes than the feed solution. The one or more solutes may include at least partially dissolved, dispersed, or suspended sugar(s), alcohol(s), volatile organic compounds (VOCs), proteins, salt(s), sugar alcohol(s), or other components of liquid systems that are capable of filtration (e.g., retention or removal) at an FO membrane. Solutes may include impermeable solutes that are substantially incapable of crossing an FO membrane (except negligible amounts of flux), such as sodium chloride, magnesium chloride, magnesium sulfate, glycerol, fructose, glucose, sucrose, polyethylene glycol, or the like The draw solution includes one or more solvents such as water or the like. The initial absence of alcohol in the draw solution provides for removal of even minute amounts of alcohol from the feed stream (e.g., alcoholic solution).

As the draw solution is fed into the individual FO stages 107, 117, and 127, the draw solution removes water and alcohol from the feed stream (e.g., alcoholic solution) due to the osmotic pressure differential between the draw and feed solutions. The draw solution is diluted by water and alcohol from the feed stream as it passed through the FO module(s) in the FO stages to form a diluted draw solution. The diluted draw solution may be processed to at least partially regenerate the draw stream. In such examples, the system 100 may include one or more distillation apparatuses, steam strippers, or reverse osmosis modules operably coupled to the draw side output (e.g., diluted draw stream outlet(s)) of the respective FO stage(s).

FIG. 1 is depicted as a countercurrent flow configuration for the draw streams as related to the feed streams in the system 100. The draw solution is fed into the system 100 from a draw source (e.g., draw solution tank or pressurized slip stream, not shown) forming draw stream 141 operably coupled to the third FO stage 127. The draw solution may be metered into the draw side of the third FO stage by a metering pump 142. Draw stream 141 may be operably coupled to, and combined with partially regenerated draw stream 143, forming draw stream 144.

Draw stream 144 may be coupled to the bottom of draw buffer tank 145 via coupling 146 which may flow in or out of the tank, or not flow at all. Draw stream 144 may be flowed through and pressurized by draw recirculation pump 147, such as to a pressure of 2 psi (13.8 kPa) less than the diluted feed stream 125 (e.g., 18 psi (124 kPa) or less). The draw stream 144 enters the draw side of the third FO stage 127, where water and alcohol is absorbed into the draw stream 144 from the diluted feed stream 125 to form diluted draw stream 148 which exits the third FO stage 127 after being diluted (third diluted draw stream). A portion of the diluted draw stream 148 may be removed as diluted draw stream 149 and transferred to the second alcohol removal stage by a metering pump 150. The remainder of diluted draw stream 148 may be directed to one or more draw regeneration apparatuses operably connected to the diluted draw stream outlet. For example, the diluted draw stream 148 may be fed into a draw buffer tank 145 operably coupled to the diluted draw stream outlet of the third FO stage 127.

The draw stream 151 may be drawn from the draw buffer tank 145 and pressurized by a high pressure pump 152 operably coupled thereto to a high pressure. For example, the high pressure may be 800 psi (5.5 MPa) to 2000 psi (13.8 MPa). The draw stream 141 may enter a third RO module 153. The third RO module may include one RO module or an array of RO modules, such as in series. The RO modules disclosed herein include a fluid tight container having a retentate side and a permeate side separated by a reverse osmosis membrane configured to allow on or both of alcohol (e.g., ethanol) and water to pass therethrough and to prevent sugars, polysaccharides, acids, minerals, and organic compounds from passing therethrough. The third RO module 153 separates the draw stream into a permeate stream 154 of water and alcohol and an at least partially regenerated draw stream 143 of draw solutes (e.g., glycerol) and water. The at least partially regenerated draw stream 143 is coupled to and may be depressurized by letdown valve 155.

Diluted draw stream 149 may be coupled and directed to the second alcohol removal stage, such as via conduits and one or more pumps 150. The diluted draw stream 149 may be combined with a second partially regenerated draw stream 163 to form draw stream 164. Draw stream 164 may be coupled to the bottom of draw buffer tank 165 via coupling 166 which may flow in or out of the tank, or not flow at all. Draw stream 164 may be coupled to and pressurized by draw recirculation pump 167 to a pressure of 2 psi (13.8 kPa) less than the second feed stream 115 (e.g., diluted feed stream), such as 18 psi (124 kPa) or less. The pressurized draw stream 164 is coupled to and enters the draw side of the second FO stage 117 where water and alcohol is absorbed into the draw stream 164 from the feed stream 115 to form the second diluted draw stream 168.

The second diluted draw stream 168 exits the second FO stage after being diluted. A portion of second diluted draw stream 168 is connected to and may be removed as stream 169 to the first alcohol removal stage, such as by a metering pump 170. The remainder of second diluted draw stream 168 is fed to the draw buffer tank 165 operably coupled thereto. Draw stream 171 may be drawn from the draw buffer tank 165 through a high pressure pump 172. The high pressure pump 172 raise the draw stream 171 to a high pressure, for example to 800 psi (5.5 MPa) to 2000 psi (13.8 MPa). The high pressure draw stream may enter a second RO module 173, where a (second) permeate stream 174 of alcohol and water is produced. The permeate stream may be directed to one or more additional separation apparatuses or to a storage vessel. In addition to the permeate stream 174, a second partially regenerated draw stream 163 is generated as the retentate of the second RO module 173. The second partially regenerated draw stream 163 may be depressurized by letdown valve 175 operably coupled thereto.

Diluted draw stream 169 may be coupled to and enter the first alcohol removal stage. For example, the second diluted draw stream 169 may be combined with partially regenerated draw stream 183 to form at least a portion of first draw stream 184. The first draw stream 184 may be coupled to the bottom of draw buffer tank 185 via coupling 186. The diluted draw solution may flow in or out of the tank 185, or not flow at all. Draw stream 184 may be coupled to and be pressurized by draw recirculation pump 187. The draw stream 184 may be pressurized to a pressure of 2 psi (13.8 kPa) less than the feed stream 105, such as 18 psi (124 kPa) or less. The pressurized draw stream 184 may enter the draw side of the first FO stage 107, where water and alcohol is absorbed into the draw stream 184 from the feed stream (105) to form a first diluted draw stream 188.

The first diluted draw stream 188 exits the first FO stage 107 after being diluted. A portion of first diluted draw stream 188 may be removed as diluted draw stream 189 and transferred out of the system 100, such as by a metering pump 190 operably coupled thereto. The remainder of first diluted draw stream 188 may be operably coupled to and fed into the draw buffer tank 185.

The diluted draw stream 188 may be removed from the draw buffer tank 185 as first diluted draw stream 191, such as via high pressure pump 192 operably coupled thereto. First diluted draw stream 191 may be pressurized to a high pressure such as 800 psi (5.5 MPa) to 2000 psi (13.8 MPa). The first diluted draw stream 191 may be coupled to and enter a first RO module 193, where a first permeate stream 194 of alcohol and water is produced, and a first partially regenerated draw stream 183 is produced. The first partially regenerated draw stream may be operably coupled to and depressurized by letdown valve (195). The first partially regenerated draw stream 183 may be combined with one or more of the second diluted draw stream 169 or the first diluted draw stream from the first buffer tank 185 to form the first draw stream 184.

The water and alcohol removed from the diluted draw streams may be processed to remove alcohol from the water, such as via distillation or stream stripping. In some examples, the RO modules may be omitted in favor of other separation apparatuses, such as steam stripping or distillation apparatuses. In such examples, the draw stream(s) may be at least partially regenerated by one or more of distillation, steam stripping, or reverse osmosis. For example, it may be desirable to direct some or all of the diluted draw streams to a single draw regeneration apparatus or single plurality of apparatuses for regenerating the draw stream(s). In such examples, the draw streams may be obtained from the same source, such as a regenerated draw stream source (e.g., tank). In some examples, RO modules may be utilized to separate water from retentates (e.g., still bottoms) of steam stripping or distillation.

The components of the system 100 may be operably coupled or otherwise fluidly connected to each other by fluid tight conduits, such as one or more of pipes, hoses, valves, slip streams, or the like.

FIG. 1 also illustrates a method of concentrating an alcoholic solution using osmosis and dilution. Accordingly, the term “stage” can refer to the physical equipment in an FO system (e.g., a group of one or more FO modules) or to the (FO) process performed therewith. The alcohol is at least partially removed from the alcoholic solution in the system 100.

An alcoholic solution (e.g., alcoholic beverage) is fed to the system 100 from a feed source 101. The alcoholic solution fed into the system 100 may initially have an alcohol concentration of 14% ABV and flow at a flow rate of 1 gpm (0.06 l/s). After the

FO processes or stages are performed utilizing dilution and concentration, the final product can include an alcohol content that is less than half, less than one eight, less than one tenth, less than one hundredth of the initial alcohol content of the alcohol solution. For example, the diluted product (e.g., alcohol solution that has had alcohol removed using FO, dilution, and concentration, then had the volume of water restored to the volume of water originally present) may have an alcohol content of less than 5% alcohol by weight (“ABW”), less than 4% ABW, less than 1% ABW, less than 0.5% ABW, or less than 0.05% ABW.

The FO systems herein utilize a first FO stage to concentrate an alcoholic solution by removing water and alcohol therefrom, and then utilize dilution and concentration with water in the concentrated feed solution to remove more alcohol in one or more subsequent

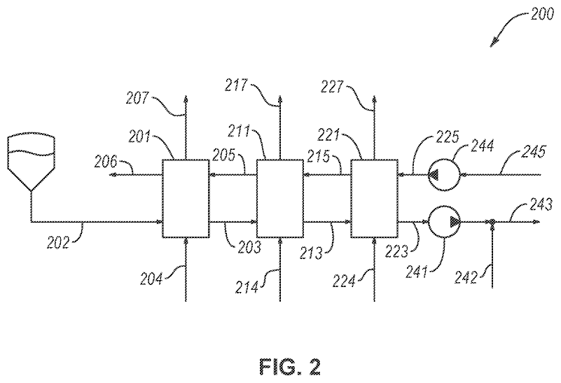

FIG. 2 is a flow diagram of a system 200 for removing alcohol from an alcoholic solution, according to an embodiment. FIG. 2 may be a simplified version of the system 100 illustrated in FIG. 1. The system 200 includes a first FO stage 201 for concentrating the feed solution by removing water and alcohol therefrom. The system 200 includes a second FO stage 211 and a third FO stage 221 for removing alcohol from the concentrated feed solution using dilution and concentration. The respective FO stages (e.g., alcohol removal stages) each include one or more FO modules similar or identical to the FO modules disclosed with respect to FO stages 107, 117, or 127, in one or more aspects. The FO stages include 201, 211, and 221 a feed stream inlet and a concentrated feed stream output for feeding and removing the alcoholic solutions.

The system includes water injection streams 204, 214, 224, and 242 operably coupled to the first FO stage 201 (e.g., alcohol removal stage), the second FO stage 211 (e.g., alcohol removal stage), and the third FO stage 221 (e.g., alcohol removal stage), and a final concentrated product output 223 of the system 200. The water injection streams may be plumbed to the respective FO stages at the FO module(s) therein for combining with the concentrated feed stream in the FO module, prior to the FO module(s) (at a feed inlet or tank) for combining with the concentrated feed stream prior to the FO module(s), or after the FO module (at a concentrated feed stream outlet) for reconstituting the alcoholic solution to form a reduced or no alcohol content beverage.

During use, the alcohol is at least partially removed from the alcoholic solution (e.g., beverage) in the system 200. The alcoholic solution is fed into the system 200 as feed stream 202, such as at a flow rate of 100 kg/h (101.1 L/h), an alcohol concentration of 14% ABV and a well rejected component concentration factor of 1×. The feed stream 202 is fed to the first FO stage 201, where alcohol and water is partially removed by the draw stream 205. The alcohol and water may be removed at a flow rate of 75 kg/h and 14% ABV. The well rejected components (e.g., sugars, polysaccharides, acids, minerals, and organic compounds) are concentrated during water removal, forming first concentrated feed stream 203 (e.g., first product having a lower alcohol content than the alcoholic solution). The first concentrated feed stream 203 is formed at a flow rate of 25 kg/h, an alcohol concentration of 14% ABV and a well rejected component concentration factor of 4×. Water is not injected into this first FO stage 201, so the flow rate of the water injection stream 204 is zero.

The first concentrated feed stream 203 is then passed on to second FO stage 211, where alcohol and water is partially removed therefrom by the draw stream 215, such as at a flow rate of 25 kg/h and 9.5% ABV. Water may be injected into the first concentrated feed stream 203 from water injection stream 214, at a flow rate of 25 kg/h, preventing the well rejected components from becoming further concentrated. These components leave the stage and form second concentrated feed stream 213 (e.g., second product with a lower alcohol content than the alcoholic solution or the first product), at a flow rate of 25 kg/h and an alcohol concentration of 4.8% ABV. The concentrated feed stream is then fed to a third FO stage 221.

In the third FO stage 221, alcohol and water are partially removed into the draw stream, such as at a flow rate of 46 kg/h and an alcohol concentration of 1.4% ABV. Water may be injected from water injection stream 224, such as at a rate of 46 kg/h, preventing the well rejected components in the feed stream from becoming further concentrated. These components leave the stage as third concentrated feed stream 223 at an alcohol concentration of 2.3% ABV and a well rejected component concentration factor of 4× (e.g., third product having a lower alcohol content than the alcoholic solution or the second product).

Water may be added to third concentrated feed stream 223 from the water injection stream 242. The water may be added at a rate of 64 kg/h to form the final diluted product stream 243 (e.g., rehydrated reduced alcohol product), which may have a flow rate of 89 kg/h, an alcohol concentration of 0.6% ABV, and a well rejected component concentration factor of 1×. In some examples, the third concentrated feed stream 223 may not be diluted with water, such as to ship a concentrate to save on shipping costs.

The water from the water injection streams 204, 214, 224, and 242 may be supplied from a water source consisting solely of water obtained solely from the alcoholic solution, such as WFW, water from beer, water from a hard cider, water from a juice (e.g., graph juice), water from a spirit, or water from an essence. In such examples, the final product may qualify for industry standards for a beverage (e.g., wine when WFW is used).

A draw stream 245 is operably coupled and directed to the third FO stage 221. For example, the draw stream 245 may be metered by metering pump 244 into the system 200 as third draw stream 225, such as at a flow rate of 330 kg/h (306.4 L/h), an alcohol concentration of 0% ABV, and a glycerin concentration of 30 wt %. Third draw stream 225 is operably coupled to and enters the draw side of the third FO stage 221, where it absorbs water and alcohol from the second concentrated feed stream 213, such as at a rate of 46 kg/h and 1.4% ABV. Some of the absorbed water and alcohol may be removed from the system 200, such as in a stream 227 at a flow rate of 46 kg/h and an alcohol concentration of 0.2% ABV. The stream 227 may be from one or more of an RO module, a distillation apparatus, or a steam stripper. The remainder of the ethanol leaves the third FO stage 221 in with draw stream 215, such as at a flow rate of 330 kg/h, an alcohol concentration of 0.2% ABV, and a glycerin concentration of 30 wt %.

Draw stream 215 is operably coupled to and enters the draw side of the second FO stage 211 where it absorbs water and alcohol from the first concentrated feed stream 203, such as at a rate of 25 kg/h and 9.5% ABV. Some of this water and alcohol may be removed from the system 200, such as in stream 217 at a flow rate of 25 kg/h and an alcohol concentration of 0.8% ABV. The stream 217 may be from one or more of an RO module, a distillation apparatus, or a steam stripper. The remainder of the ethanol leaves the second FO stage 211 mixed in with draw stream 205, such as at a flow rate of 330 kg/h, an alcohol concentration of 0.8% ABV, and a glycerin concentration of 30 wt %.

The draw stream 205 is connected to and enters the draw side of the first FO stage 201, where it absorbs water and alcohol at a rate of 75 kg/h and 14% ABV. Some of this water and alcohol (e.g., ethanol) is removed from the system 200 as stream 207, such as at a flow rate of 75 kg/h and an alcohol concentration of 3.3% ABV. The remainder of the ethanol may leave the first FO stage 201 mixed in with diluted draw stream 206, such as at a flow rate of 330 kg/h, an alcohol concentration of 3.3% ABV, and a glycerin concentration of 30 wt %.

In some examples, the streams 217 and 227 containing alcohol and water coming out of FO stages 211 and 221, respectively, may be partially recycled without removing any alcohol from them and injected as the water injection streams 214 and 204. In such examples, the water injection stream 224 and 242 are substantially alcohol free. The streams 227, 217, and 207 may be processed to fully or partially remove alcohol therefrom. In such examples, the water separated from the alcohol from streams 227, 217, and 207 may be reused in one or more of streams 204, 214, 224, and 242. For example, water from one or more of streams 227, 217, or 207 may be processed to at least partially remove alcohol therefrom and the resulting water can be reused as water injection stream 242 to at least partially rehydrate the third concentrated feed stream 223 to form the final diluted product stream 243. By utilizing only water removed from the feed stream (or alcoholic beverage such as wine) to form the draw streams 205, 215, 225, and 245, water from the draw streams may be utilized to rehydrate the third concentrated feed stream 223 to form the final diluted (e.g., rehydrated) product stream (243) without introducing water from a source outside of the alcoholic beverage in the feed stream. Accordingly, wine may be dealcoholized, concentrated, and rehydrated to form reduced alcohol wine, without using water from another source.

Similarly, diluted draw stream 206 discharged from the first FO stage 201 may be processed to fully or partially remove alcohol therefrom to at least partially regenerate the draw stream 245. Accordingly, the diluted draw stream may be reused as draw stream 245.

In examples, water and alcohol in the diluted draw stream may be separated from the solutes (e.g., glycerin) therein by RO using an RO module having an RO membrane composed to allow water and ethanol to pass therethrough but prevent glycerin from passing therethrough. The permeate of the RO module includes substantially only water and alcohol. Alcohol removal from RO permeate or diluted draw stream can be performed via a variety of separation processes such as distillation, steam stripping, and extraction. In addition to the streams for reuse in the dealcoholization (e.g., draw stream 245, and water injection streams 204, 214 and 224, distillation can produce alcohol at high concentration while steam stripping generally results in lower concentration alcohol in condensed steam (for example, 17.2% ABW from diluted draw stream 206 and 6.7% ABW from streams 204, 214 and 224).

Separating the liquid constituents in the diluted draw streams and/or RO permeates works by a process of heat application. Because each liquid constituent has its own boiling point and volatility level, heat application gradually raises these substances to their boiling point, converting them into vapor, which removes them from the original liquid mixture. Because the liquid mixture is gradually brought to a boil, the constituents with the lowest boiling point are the first and easiest ones to remove. For example, water boils at 100° C., while ethanol boils at about 78° C. By heating a water-ethanol mixture to about 90° C., the ethanol is converted from a liquid state into a vapor, effectively removing it from the diluted draw stream or RO permeate and leaving behind the water. The distillation process occurs in a distillation column—a piece of equipment designed to contain the feed, apply heat to it, condense the volatiles, and collect the separated constituents as distillate (e.g., ethanol) and still bottoms (e.g., water). Suitable distillation columns may include any number of trays suitable to remove alcohol from diluted draw solutions and RO permeates.

Unlike the distillation, which often has a fluid inlet (e.g., for the diluted draw stream) in the middle of the column, steam stripping has a fluid inlet at the top of the stripping column. The steam inlet is located at the bottom of the stripping column. This is referred to as a countercurrent design because the steam and the feed are being introduced from opposite ends of the stripping column. As solution to be separated flows from the top of the column downward, it washes over porous packing material or trays designed to increase the amount of contact surface where the steam and the feed meet. As the steam gets introduced into the feed, the volatiles with the lowest boiling point are first to be absorbed into the steam upon contact with it. Volatiles with higher boiling points do not undergo this process, but if they have lower water solubility, they'll still get absorbed into the steam and be removed with it. The steam containing the absorbed ethanol exits the top of the column, where it is collected, and condensed while the liquid that is not taken up in the steam falls to the bottom of the column where it is collected. Suitable steam strippers may be configured to receive culinary steam from a culinary steam generator, in order to maintain the water food safe.

FIG. 2 also illustrates a flow chart of a method for concentrating an alcoholic beverage using osmosis, dilution, and concentration, according to an embodiment.

While three alcohol removal (e.g., FO) stages are depicted in FIGS. 1 and 2, more than three alcohol removal stages may be utilized to concentrate an alcoholic solution by removing alcohol therefrom using FO, dilution, and concentration. For example, suitable systems and techniques for removing alcohol from an alcoholic solution may include a first FO stage for concentrating the alcoholic solution and any number of the subsequent plurality of FO stages for diluting, concentrating, and separating alcohol from the alcoholic solution, such as at least 2 FO stages (e.g., total of 3 FO stages), at least 3 FO stages, at least 5 FO stages (e.g., total of 6 FO stages), or at least 8 FO stages.

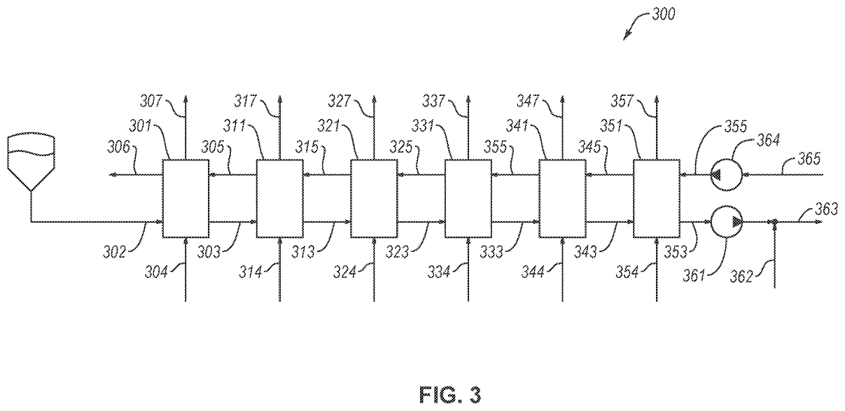

FIG. 3 is a block diagram of a system 300 for removing alcohol from an alcoholic solution, according to an embodiment. Alcohol is at least partially removed from the alcoholic solution (e.g., beverage) in the system 300. The system 300 includes 6 FO stages 301-351. The FO stages 301, 311, 321, 331, 341, and 351 may be similar or identical to the FO stages disclosed above with respect to FIG. 1 or FIG. 2, in one or more aspects such as having one or more FO membrane modules each. For example, the FO stages may be similar or identical the FO stages 201-221 of the system 200 in one or more aspects. The feed side of the FO stages 301, 311, 321, 331, 341, and 351 includes a feed inlet for inputting a feed stream into the FO stage and a concentrated feed outlet for outputting a concentrated feed stream. The draw side of the FO stages 301, 311, 321, 331, 341, and 351 include a draw inlet for inputting a draw stream into the FO stage and a diluted draw outlet for outputting a diluted draw stream. The system 300 includes water injection streams 304, 314, 324, 334, 344, and 354 operably coupled to the system 300 prior to or at the corresponding FO stages 301-351, respectively. The water injection streams may be used to add water to concentrated feed streams for dilution and concentration. An additional water injection stream 362 operably coupled to a final concentrated feed stream may be used to reconstitute a reduced alcohol product solution.

In a first FO process, the alcoholic solution is fed to the feed side of a first FO stage 301 of the six stage alcohol removal system 300 as feed stream 302, such as at a flow rate of 100 kg/h (101.1 L/h), an alcohol concentration of 14% ABV and a well rejected component concentration factor of 1×. The alcohol and water is partially removed from the feed stream 302 into the first draw stream 305, such as at a flow rate of 37.5 kg/h and 14% ABV. The well rejected components in the feed stream 302 may be concentrated, forming first concentrated feed stream 303 (e.g., first product), at a flow rate of 62.5 kg/h, an alcohol concentration of 14% ABV and a well rejected component concentration factor of 1.6×. Water is not injected into the feed solution at the first FO stage 301, so the flow rate of the water injection stream 304 is zero. In some examples, water may be injected at this stage in some examples to reach a selected concentration of well rejected components.

The first concentrated feed stream 303 is then passed into a second FO stage 311 to perform a second FO process. The alcohol and water therein may be at least partially removed, such as at a flow rate of 37.5 kg/h and 14% ABV, and the well rejected components are concentrated, forming the second concentrated feed stream 313 (e.g., second product stream), a flow rate of 25 kg/h, an alcohol concentration of 14% ABV and a well rejected component concentration factor of 4×. Water may not be injected into this stage, so the flow rate of the water injection stream 314 may be zero. In some examples, water may be injected at this into the first concentrated feed stream 303 from the water injection stream 314 to reach a selected concentration of well rejected components. For example, the volume of water removed from the first feed stream 302 may be replaced by the water injection stream 314 to form a first diluted solution (e.g., beverage), such as prior to or in the second FO stage 311.

The second concentrated feed stream 313 is then fed into a third FO stage 321 to perform a third FO process. Alcohol and water are partially removed from the second concentrated feed stream 313, such as at a flow rate of 25 kg/h and an alcohol concentration of 9.4% ABV. Water may be injected into the second concentrated feed stream 313 via water injection stream 324, such as at a rate of 25 kg/h, prior to or in the third FO stage 321 (e.g., into the FO module(s)). The water injected may replace the volume of water removed from the FO stages, preventing the well rejected components from becoming further concentrated, and forming third diluted solution (e.g., beverage). These components may leave the third FO stage 321 as third concentrated feed stream 323 (e.g., third product stream) at a flow rate of 25 kg/h, an alcohol concentration of 4.8% ABV, and a well rejected component concentration factor of 4×.

The third concentrated feed stream 323 is then fed to fourth FO stage 331 to perform a fourth FO process. In the fourth FO stage 331, alcohol and water are partially removed from the third concentrated feed stream 323 at a flow rate of 50 kg/h and an alcohol concentration of 1.6% ABV. Water may be injected into the third concentrated feed stream 323 via water injection stream 334, such as at a rate of 50 kg/h (e.g., the volume of water removed from the feed stream in the FO stages) to form third diluted stream prior to circulation through the fourth FO stage 331, thereby preventing the well rejected components from becoming further concentrated. These components may leave the fourth FO stage 331 as fourth concentrated feed stream 333 (e.g., fourth product stream), such as at a flow rate of 25 kg/h, an alcohol concentration of 1.6% ABV, and a well rejected component concentration factor of 4×.

The fourth concentrated feed stream 333 is then fed to a fifth FO stage 341 to perform a fifth FO process. In the fifth FO stage 341, alcohol and water are partially removed from the fourth concentrated feed stream, such as at a flow rate of 75 kg/h and an alcohol concentration of 0.4% ABV. Water may be injected into the fourth concentrated feed stream 333 via water injection stream 344 to form the fourth diluted feed stream (e.g., beverage) prior to circulation through the fourth FO stage 331, such as at a rate of 75 kg/h, preventing the well rejected components from becoming further concentrated. These components leave the fifth FO stage 331 as fifth concentrated feed stream 343 (e.g., fifth product stream) at a flow rate of 25 kg/h, an alcohol concentration of 0.6% ABV, and a well rejected component concentration factor of 4×.

The fifth concentrated feed stream 343 is then fed to a sixth FO stage 351 to perform a sixth FO process. In the sixth FO stage 351, alcohol and water are partially removed from the fifth concentrated feed stream at a flow rate of 110 kg/h and an alcohol concentration of 0.1% ABV. Water may be injected into the fifth concentrated feed stream 343 via water injection stream 354 at a rate of 110 kg/h (e.g., the volume of water removed from the feed stream in the FO stages) to form the fifth diluted feed stream prior to circulation through the sixth FO stage 351, thereby preventing the well rejected components from becoming further concentrated.

These well rejected components leave the sixth FO stage as a concentrated feed stream 353 (e.g., product stream) at a flow rate of 25 kg/h, an alcohol concentration of 0.2% ABV, and a well rejected component concentration factor of 4×. Water may be injected into the concentrated feed stream 353 from water stream 362 to form a diluted solution (e.g., reduced alcohol product). For example, water may be added to the concentrated feed stream 353 at a rate of 64 kg/h to form the final diluted (e.g., rehydrated) product stream 363, which has a flow rate of 89 kg/h, an alcohol concentration of 0.06% ABV, and a well rejected component concentration factor of 1×. The water stream 362 may be provided from recycling water from one or more of diluted draw streams 307, 317, 327, 337, 347, or 357, such as by separating the water from the alcohol and glycerin therein using one or more of reverse osmosis, distillation, or steam stripping.

At each stage after dilution of the concentrated feed stream starts, the alcohol content of the feed stream is reduced compared to a previous feed stream, such that the concentrated feed streams each have less alcohol than the previous concentrated feed stream and the original feed stream. Accordingly, the alcohol is reduced until a selected amount is reached.

A sixth draw solution stream 365 fed into the system 300 via the sixth FO stage 351. The sixth draw solution stream 365 may be metered by metering pump 364 into the draw side of the system 300, such as at a flow rate of 330 kg/h (306.4 L/h), an alcohol concentration of 0% ABV, and a glycerin concentration of 30 wt %.

The pressurized sixth draw stream 355 enters the sixth FO stage 351, where it absorbs water and alcohol from the fifth diluted feed stream (e.g., containing the fifth concentrated feed stream 343 and water) at a rate of 110 kg/h and 0.1% ABV. Some of this water and alcohol is removed from the system 300 as stream 357 (e.g., one or more of a permeate stream, distillate, still bottoms, or the like), such as at a flow rate of 110 kg/h and an alcohol concentration of 0.03% ABV. The remainder of the ethanol leaves mixed in with fifth draw stream 345, and exits the sixth FO stage 351, such as at a flow rate of 330 kg/h, an alcohol concentration of 0.03% ABV, and a glycerin concentration of 30 wt %.

The fifth draw stream 345 enters the fifth FO stage 341, where it absorbs water and alcohol from the fourth diluted feed stream (e.g., containing the fourth concentrated feed stream 333 and water), such as at a rate of 75 kg/h and 0.4% ABV. Some of this water and alcohol is removed from the system 300 as stream 347 (e.g., one or more of a permeate stream, distillate, still bottoms, or the like), such as at a flow rate of 75 kg/h and an alcohol concentration of 0.1% ABV. The remainder of the ethanol leaves mixed in with fourth draw stream 335, and exits the fifth FO stage 341, such as at a flow rate of 330 kg/h, an alcohol concentration of 0.1% ABV, and a glycerin concentration of 30 wt %.

The fourth draw stream 335 enters the fourth FO stage 331 (e.g., alcohol removal stage), where it absorbs water and alcohol from the third diluted feed stream (e.g., containing the third concentrated feed stream 323 and water), such as at a rate of 50 kg/h and 1.6% ABV. Some of this water and alcohol is removed from the system 300 as stream 337 (e.g., one or more of a permeate stream, distillate, still bottoms, or the like), such as at a flow rate of 50 kg/h and an alcohol concentration of 0.3% ABV. The remainder of the ethanol leaves mixed in with third draw stream 325, and exits the fourth FO stage 331, such as at a flow rate of 330 kg/h, an alcohol concentration of 0.3% ABV, and a glycerin concentration of 30 wt %.

Third draw stream 325 enters the third FO stage 321, where it absorbs water and alcohol from the second diluted feed stream (e.g., containing the second concentrated feed stream 313 and water), such as at a rate of 25 kg/h and 9.4% ABV. Some of this water and alcohol is removed from the system 300 as stream 327 (e.g., one or more of a permeate stream, distillate, still bottoms, or the like), such as at a flow rate of 25 kg/h and an alcohol concentration of 0.9% ABV. The remainder of the ethanol leaves mixed in with second draw stream 315, and exits the third FO stage 321, such as at a flow rate of 330 kg/h, an alcohol concentration of 0.9% ABV, and a glycerin concentration of 30 wt %.

The second draw stream 315 enters the second FO stage 311, where it absorbs water and alcohol from the first diluted feed stream (e.g., containing the first concentrated feed stream 300 stream 317 and water), such as at a rate of 37.5 kg/h and 14% ABV. Some of this water and alcohol is removed from the system 300 as stream 317 (e.g., one or more of a permeate stream, distillate, still bottoms, or the like), such as at a flow rate of 37.5 kg/h and an alcohol concentration of 2.3% ABV. The remainder of the ethanol leaves mixed in with the first draw stream 305, and exits the second FO stage, such as at a flow rate of 330 kg/h, an alcohol concentration of 2.3% ABV, and a glycerin concentration of 30 wt %.

The first draw stream 305 enters the first FO stage 301. In the first FO stage, the first draw stream 305 absorbs water and alcohol form the feed stream 302, such as at a rate of 37.5 kg/h and 14% ABV. Some of this water and alcohol is removed from the system 300 as diluted draw stream 307 (e.g., one or more of a permeate stream, distillate, still bottoms, or the like), such as at a flow rate of 37.5 kg/h and an alcohol concentration of 3.5% ABV. The remainder of the ethanol leaves mixed in with draw stream 306, and exits the first FO stage 301, such as at a flow rate of 330 kg/h, an alcohol concentration of 3.5% ABV, and a glycerin concentration of 30 wt %.

In some examples, the streams 317, 327, 337, 347, and 357 coming out of the additional FO stages 311-351 may be partially recycled without removing any alcohol from them and injected as the water injection streams 344, 334, 324, 314, and 304. The streams 307, 317, 327, 337, 347, and 357 may also be processed to fully or partially remove alcohol from the water therein and the water that is separated from the alcohol (e.g., ethanol) can be reused in one or more of water injection streams 304, 314, 324, 334, 344, 354, or 362.

The draw streams 365, 345, 335, 325, 315, and 305 may be obtained from one or more of recycling at least a portion of the preceding draw stream, a fresh supply of draw stream, water from a previous draw stream, or water from a similar solution as the feed solution (e.g., WFW), or the like. For example, a diluted draw stream outlet of one or more of FO stages 301-351 may be fluidly connected to at least one draw stream regeneration apparatus which receives the diluted draw solution(s) therefrom and separates one or more of water or alcohol from the diluted draw stream or a derivative of the diluted draw stream. The at least one draw stream regeneration apparatus may include one or more of an RO module(s), a steam stripper, or a distillation column. The draw stream inlet of one or more of FO stages 301-351 may be fluidly connected to a draw stream source, such as individual or a common draw stream source, one or more draw stream regeneration apparatuses, or a draw stream outlet of a previous FO stage or module.

Water from one or more of streams 307-357 may be processed to at least partially remove alcohol therefrom and the resulting water can be reused as water injection stream 362 to at least partially rehydrate the concentrated feed stream 353 to form the final product stream 363 (e.g., diluted reduced alcohol solution).

FIG. 3 also illustrates a flow chart for concentrating an alcoholic solution using osmosis, dilution, and concentration, according to an embodiment.

In some examples, the alcoholic solution in a feed stream may be processed in multiple FO stages before water is added to the concentrated feed stream resulting therefrom. In such examples, the FO stages may include a plurality of FO modules or may include one FO module through which the feed stream is recirculated any number of times, such as 2 or more times, 2-6 times, 3-6 times, or less than 10 times.

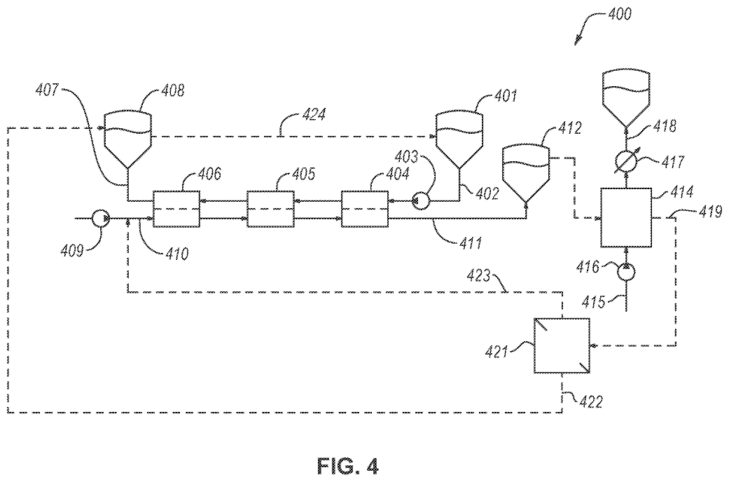

FIG. 4 is a block diagram of an embodiment of a system 400 for removing alcohol from alcoholic solutions using dilution and concentration, according to an embodiment. In the system 400, the alcoholic solution can be processed multiple times to remove alcohol therefrom. With each subsequent pass through the system 400 the alcohol content (e.g., concentration) in the alcoholic solution is reduced.

The system 400 includes a first FO stage 404, a second FO stage 405, and a third FO stage fluidly connected in a counter current flow configuration. For example, a feed stream is passed through the first FO stage 404 to the second FO stage 405 and finally to the third FO stage 406. A draw stream is passed through the third FO stage 406 to the second FO stage 405 and finally to the first FO stage 404. The system includes a feed source 401 operably coupled to the first FO stage 404. The feed source 401 stores or supplies an alcoholic solution such as an alcoholic beverage (e.g., beer, wine, hard cider, spirits). The system includes product tank 408 for storing the at least partially diluted and dealcoholized product solution, such as an at least partially rehydrated reduced or non-alcoholic beverage. The system 400 includes the diluted draw tank 412 for storing diluted draw solution produced form the draw side of the system 400. The system 400 may include a steam stripper 414 and condenser 417 for condensing a stream of water and alcohol from a steam stripper 414. The steam stripper 414 may include any of the steam strippers disclosed herein, such as a steam stripper with a culinary steam source. The steam stripper 414 and condenser 417 may be omitted in favor of a distillation column. The system 400 includes storage tank 418 for storing a solution of water and alcohol recovered from the diluted draw stream 411, such as via the steam stripper 414. The system may include an RO system 421 comprising an RO module or array. The system 400 includes one or more pumps 403, 409, and 416 for pressurizing various streams therein.

FIG. 4 also illustrates a method of concentrating an alcoholic solution using osmosis, dilution, and concentration. In the first pass through the system 400, an alcoholic solution is fed to the system 400 from feed source 401 (e.g., tank or constant pressure slip stream). The alcoholic solution forms feed stream 402 and may have an alcohol concentration of 11.25% ABW and it is fed into the system at a flow rate of 100 l/h, an alcohol concentration of 14% ABV and a well rejected component concentration factor of 1×.

Feed stream 402 enters the three-stage FO system into the first FO stage 404, continuing to the second FO stage 405, and then to the third FO stage 406. Each of the stages of FO include one or more FO modules including a fluid tight container having a feed side and a draw side separated by a FO membrane capable of allowing alcohol (e.g., ethanol) and water to pass therethrough and to prevent sugars, polysaccharides, acids, minerals, and organic compounds (e.g., above 100 AMU's) from passing therethrough. Each stage may be utilized with a selected draw stream to remove a selected amount of alcohol and water from the feed stream, which may differ between stages.

A draw solution is fed to the system 400 from a draw source, such as tank or pressurized slip stream, forming draw stream 410 which is metered into the third FO stage 406 by a metering pump 409. Draw stream 410 may be fed into the third of the three FO stages as 28 wt % glycerol at the rate of 50 l/h. Draw stream 410 may be pressurized by metering pump 409 (e.g., draw recirculation pump) to a pressure of 2 psi (13.8 kPa) less than the pressure of the feed stream 402, for example at 18 psi (124 kPa) or less. The draw stream 410 enters the draw side of the third FO stage 406 (e.g., third FO module, or array of modules) where, through FO stages 406, 405, and 404 the water and alcohol is absorbed into the draw stream 410 from the feed stream 402 to form diluted draw stream 411. The diluted draw stream 411 is output from the first FO stage 404. A concentrated and dealcoholized feed stream exits the third FO stage 406 as concentrated feed stream 407, such as with alcohol at a concentration of approximately 9% ABW and at a well rejected component concentration factor of 3.5×. The diluted draw stream 411 may exit the FO stages at 11.5 wt % glycerol and 7.4% ABW and may be stored in the diluted draw tank 412.

The diluted draw stream 411 may be at least partially regenerated, such as by a combination of steam stripping and reverse osmosis. For example, the diluted draw stream 411 may have a concentration 11.5 wt % glycerol and 7.4% ABW and can be processed with steam stripping with a steam stripper 414 (e.g., steam stripping column), a condenser 417, pumps, and instrumentation. Steam stripping results in alcohol removal from the diluted draw stream 411. In the steam stripper 414, the alcohol from the diluted draw stream 411 migrates into the steam and is then condensed in the condenser 417 to create a solution of alcohol in water at ABW of above 1% ABW in storage tank 418.

The diluted and steam stripped draw stream 419, at the concentration of 12.4 wt % glycerol, may be further processed to remove more water therefrom. For example, the stream 419 may be further processed through RO system 421. In the RO system 421 the stream 419 may be pressurized by a pump, such as to at least 1000 psi (6.9 MPa). The RO system 421 includes a fluid tight container having a supply or retentates side and a permeate side separated by a reverse osmosis membrane capable of allowing water to pass therethrough (responsive to hydrostatic pressure applied by the stream in the supply side) and to prevent draw solutes (e.g., glycerol) from passing therethrough. RO system 421 may concentrate the glycerol in the steam stripped draw stream 419, such as to form at least partially regenerated draw stream 423. The RO system 421 produces a water stream 422 as a permeate. The volume of water and retentate corresponds to the water removed from the initial feed stream 402. The at least partially regenerated draw stream 423 may have a glycerol content of 28 wt %. The at least partially regenerated draw stream 423 can be reused as at least a portion of draw stream 410 to initiate the concentration and dealcoholization process.

Concentrated feed stream 407 can be diluted with the water stream 422, such as in product tank 408 to create a diluted dealcoholized solution 424 at a well rejected component concentration factor of 1.1× and ABW of 2.93%. By utilizing the water stream 422 as make-up water to at least partially reconstitute the feed solution, the resulting diluted dealcoholized solution 424 only contains material from the original feed stream 402. For example, when wine is cycled through the system 400, the draw stream 411 may comprise only WFW which is then at least partially recycled for use in the water stream 422 as disclosed herein.

In some instances, the diluted draw stream 411 may be processed to recover water 422 removed and combined with at least partially regenerated draw stream 423 to at least partially regenerate the draw stream, such as via one or more of distillation, reverse osmosis, or steam stripping in any combination or order of the foregoing.

If further dealcoholizing and concentration is needed, the diluted dealcoholized solution 424 may be fed and processed through the system 400 again for further processing.

In some examples, a single FO module may be utilized to concentrate an alcoholic solution using dilution and concentration. In such examples, the single FO module may be utilized to both concentrate the alcoholic solution and then for dilution of the alcoholic solution. Such operational processes and conditions may be time or compositionally based.

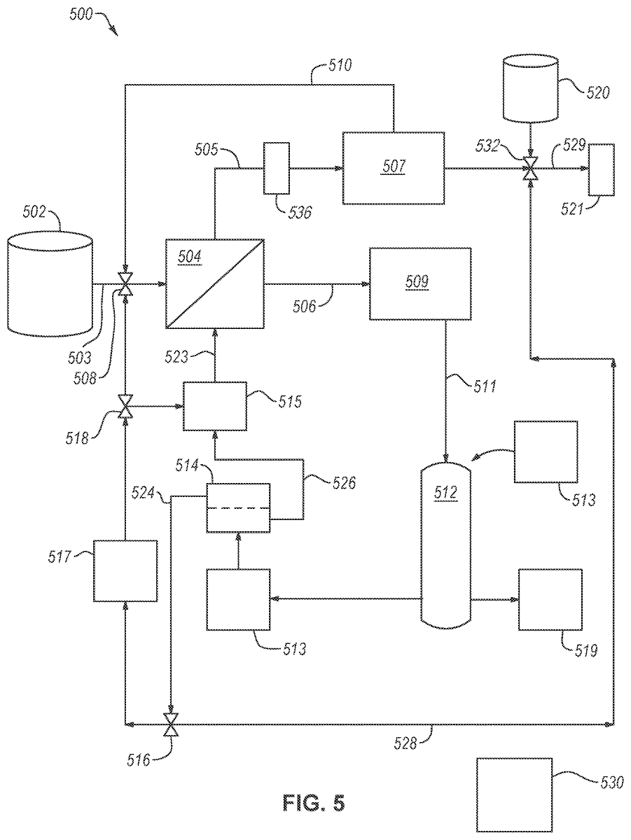

FIG. 5 is a block diagram of a system 500 for removing alcohol from alcoholic solutions using dilution and concentration, according to an embodiment. The system 500 includes an FO stage 504 for separating alcohol and water from an alcoholic solution. The FO stage 504 may be similar or identical to any of the FO stages disclosed herein, in one or more aspects. For example, the FO stage 504 may include one or more FO modules having one or more FO membranes separating a feed side from a draw side, where the FO modules are connected in series or even in parallel. A feed stream 503 of an alcoholic solution (e.g., alcoholic beverage) is supplied to the FO stage 504 from a feed source 502 to form a concentrated feed stream 505 having a higher concentration of well rejected components then the feed stream 503 and to form a diluted draw stream 506 having a higher water content and alcohol content than the draw stream 523.

The system 500 includes a feed recirculation loop on a feed side of the FO stage 504 and a draw recirculation loop on a draw side of the FO stage 504. The feed recirculation loop includes a concentrated feed supply 507 (e.g., tank, reservoir, or conduit) connected to a feed input of the FO stage 504 by a conduit and one or more valves 508. For example, the concentrated feed stream 505 may be directed to the feed side of the FO stage 504 via concentrated feed recirculation stream 510 to form at least a portion of the feed stream 503. The valve 508 may be actuated to supply a selected amount of feed stream 503 and/or concentrated feed stream into the FO stage 504. For example, in recirculation operations predominantly or substantially only concentrated feed stream may be directed into the FO stage 504 via the valve 508.

The system 500 includes the draw regeneration system such as having one or more of a steam stripper 512, a distillation column (not shown), or an RO system 514. For example, the diluted draw stream 506 may be directed to a diluted draw stream storage 509, such as a tank, reservoir, or conduit. The diluted draw stream may be removed from the draw stream storage 509 as diluted draw stream 511 to the draw regeneration system For example, the diluted draw stream 511 may be directed into steam stripper 512 where steam from a culinary steam generator 531 may be directed to volatilize and entrain alcohol therein. The entrained alcohol (and some water) may be removed as a distillate into a distillate storage 519.

The water and draw solution that is not entrained in the steam may be removed from the steam stripper 512 into a dealcoholized and diluted draw stream such as into diluted and dealcoholized draw tank 513. The diluted and dealcoholized draw stream may be further processed to remove water therefrom, such as at and RO system 514. Water may be removed from the diluted and dealcoholized draw stream to a selected concentration to provide a water permeate 524 and an at least partially regenerated draw stream 526 as a retentate. The at least partially regenerated draw stream 526 may be directed into draw source 515. The draw source 515 may include any of the draw streams disclosed herein and may be supplemented by water permeate 524. The water permeate 524 may be directed to a water source 517 via valve 516. The water permeate from the water source 517 may be directed to the draw source 515 or the concentrated feed stream 510 via the valve 518. The draw stream 523 is directed into the draw side of the FO stage 504, such as via a pump (not shown).

At least a portion of the concentrated feed supply may be utilized to form a product, such as a dealcoholized feed solution or beverage that may be diluted to at least a portion of the volume of the feed stream. For example, water from a water source 520 containing WFW or the like may be added to the concentrated feed stream from the concentrated feed supply 507, such as via a valve 532 or in a tank (not shown) to form at least a portion of the dealcoholized and diluted feed solution 529 (e.g., dealcoholized beverage). Water recovered from the diluted draw stream 506 may be combined with the concentrated feed stream from the concentrated feed supply 507, such as via the valve 532, to form dealcoholized and diluted feed solution 529. For example, at least a portion of the water permeate 524 may be directed to the concentrated feed stream via the valve 516 and the valve 532 to form the dealcoholized and diluted feed solution 529 (e.g., dealcoholized beverage).

One or more components of the system 500 may be controlled by a controller 530. For example one or more pumps, valves, or sensors operably coupled to, and disposed between, any of the components of the system 500 may be in electronic communication with (e.g., wirelessly connected or wired) and controlled by the controller 530. For example a sensor 534 disposed on an outlet of the feed side of the FO stage 504 to detect an amount of alcohol therein. For example, the at least one sensor 534 may include an Anton-Paar Alcolyzer instrument (available from ANTON PAAR GmbH of Graz, Austria) or any other instrument capable of detecting the concentration of alcohol, real extract, density, or other properties of a fluid stream. Based on the sensed data from the sensor 534, the concentrated feed stream may be allocated for recirculation or output from the system 500. For example, if an alcohol content of the concentrated feed stream is at or below a selected amount, the controller may actuate one or more valves of pumps to output the concentrated feed stream for rehydration and/or output from the system 500. If the alcohol content is above a selected amount the controller 530 may actuate one or more pumps or valves to recirculate the concentrated feed stream 505 to the FO stage 504 via the recirculation line containing concentrated feed stream 510. The concentrated feed stream may be recirculated as many times as needed to reach a selected alcohol concentration relative to a selected real extract percentage, such as at least 1 time, 1 to 3 times, 3 to 5 times, more than 5 times, more than 100 times, more than 1000 times, less than 100 times, or less than 10 times. The sensor 534 may include a flow meter, a scale, or the like to determine the volume and/or weight of a concentrated feed solution.

The concentrated feed stream that is recirculated back to the FO stage 504 may have water added thereto to dilute the concentrated feed stream so that more alcohol may be removed through the FO membrane into the draw stream 523.

Based on the amount of alcohol and volume of the concentrated feed stream 505, the controller 530 may direct the addition of a selected amount of water from one or more of water source 520 or the water stream 528 to reach a selected dilution of the concentrated feed stream to form the diluted and dealcoholized feed solution 529. The controller 530 may also direct the addition of a selected amount of water based on the amount of alcohol and the real extract percentage of the feed solution 505.

The dealcoholized feed solution 529 may be directed to a storage tank 521, such as one or more tanks, vats, trucks, bottles, barrels, or the like.

Any of the systems disclosed herein may include a feed stream source operably coupled to the feed side of an initial FO stage or module, The feed stream source may contain any of the feed streams, alcoholic solutions, or alcoholic beverages disclosed herein.

The systems disclosed herein may be utilized to remove alcohol from alcoholic solutions. The methods below as well as the system diagrams presented in FIGS. 1-5 provide methods for dealcoholizing alcoholic solutions (e.g., beverages) using FO, dilution, and concentration.

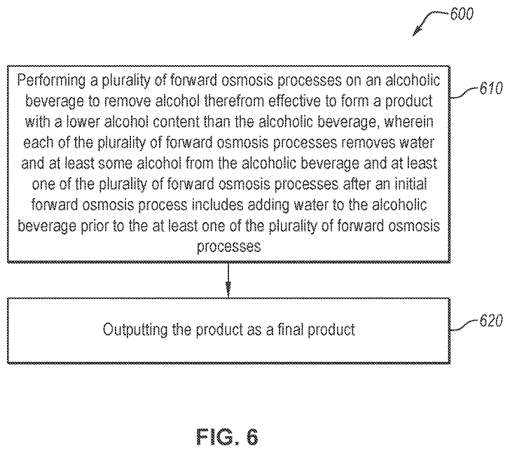

FIG. 6 is a flow diagram of a method 600 for removing alcohol from an alcoholic solution, according to an embodiment. The method 600 includes an act 610 of performing a plurality of FO processes on an alcoholic solution to remove alcohol therefrom effective to form a product with a lower alcohol content than the alcoholic solution, wherein each of the plurality of FO processes removes water and at least some alcohol from the alcoholic solution and at least one of the plurality of FO processes after an initial FO process includes adding water to the alcoholic solution prior to the at least one of the plurality of FO processes, and an act 620 of outputting the product as a final product. The method 600 may include more or fewer acts than the acts 610 and 620. For example, one or more of the acts 610 or 620 may be split into more acts, omitted, or combined. Additional acts may be utilized as well.

The act 610 of performing a plurality of FO processes on an alcoholic solution to remove alcohol therefrom effective to form a product with a lower alcohol content than the alcoholic solution may include circulating the alcoholic solution through a feed side of an FO stage. For example, the act 610 of performing a plurality of FO processes on an alcoholic solution to remove alcohol therefrom effective to form a product with a lower alcohol content than the alcoholic solution may include circulating a feed solution (e.g., alcoholic beverage) through a feed side of an FO stage and circulating a draw solution having a lower alcohol content than one or more of the alcoholic solution or product through a draw side of and FO stage corresponding to a specific FO process (e.g., through the same FO module as the feed solution noted above). The FO stage or module(s) may include any of the FO stages or modules disclosed herein.

Performing a plurality of FO processes on an alcoholic solution may include performing a plurality of FO processes on an alcoholic beverage such as beer, wine, hard cider, spirits, or on extracts for flavors or perfumes. Performing a plurality of FO processes on an alcoholic solution (e.g., beverage) to remove alcohol therefrom may include performing a first FO process on an alcoholic solution to remove alcohol and water therefrom to form a first product (e.g., first concentrated feed stream), adding water to the first product to form a first diluted solution (e.g., beverage) having a lower alcohol content than the alcoholic solution, performing a second FO process on the first diluted solution to remove alcohol and water therefrom to form a second product (e.g., second concentrated feed stream), and adding water to the second product to form a second diluted solution having a lower alcohol content than the first product. Performing a plurality of FO processes on an alcoholic solution to remove alcohol therefrom may include any number of FO processes (e.g., travel through a feed side of an FO module or array) and water additions, such as 2 or more, 2-10,000, 2-10, 2-100, 2-1,000, 1,000-5,000, 5,000-10,000, or less than 10,000 FO processes and water additions. For example, the alcoholic solution may be constantly recycled through an FO stage many times while water is steadily added to maintain a volume of the alcoholic solution while water and alcohol is removed into the draw stream via the FO membrane. In embodiments, performing a plurality of FO processes on an alcoholic solution to remove alcohol therefrom may further include performing a third FO process on the second diluted solution to remove alcohol therefrom and form a third product with a lower alcohol content than the second product, adding water to the third product to form a third diluted solution having a lower alcohol content than the second product, and performing at least a fourth FO process on the third diluted solution (e.g., beverage) to remove alcohol therefrom and form a fourth product with a lower alcohol content than the third product.

Performing a plurality of FO processes on an alcoholic solution (e.g., beverage) to remove alcohol therefrom includes forming a diluted draw stream containing alcohol removed from the alcoholic solution. For example, each of the plurality of FO processes removes water and at least some alcohol from the alcoholic solution into a draw stream to form a diluted draw stream. The draw stream may include any of the draw streams disclosed herein, such as a draw stream having a higher total solutes (e.g., permeable and/or impermeable solutes) concentration than the alcoholic solution. Suitable draw streams may include at least 20% glycerol by weight, at least 25% glycerol, 20% to 30%, 25% to 35%, or at least 35% glycerol by weight.

The method 600 may further include separating the alcohol removed from the alcoholic solution from the diluted draw stream to at least partially reform the draw stream, such as by one or more of RO, steam stripping, or distillation.

In some examples, performing a plurality of FO processes on an alcoholic solution to remove alcohol therefrom may include recirculating the product through a single FO stage to perform each FO process. In some examples, performing a plurality of FO processes on an alcoholic solution to remove alcohol therefrom may include circulating each product through a subsequent FO stage (e.g., FO module or array) to perform each FO process.

Performing a plurality of FO processes on an alcoholic solution to remove alcohol therefrom may include concentrating one or more well rejected components in the alcoholic solution to a concentration of about 3 or more times of an original concentration of the one or more well rejected components in the alcoholic solution, such as 3 times to 50 times the concentration, 3 times to 10 times the concentration, 3 times to 5 times the concentration 5 times or ten times the concentration, or more than 10 times the concentration of the well rejected components in the original alcoholic solution.

Adding water to the alcoholic solution may include adding water to the product may include adding only the volume of water that was removed in a selected one or more of the FO processes, thereby leaving the alcoholic solution in a concentrated state due to the unreplaced volume of removed alcohol. Adding water to the alcoholic solution may include adding water to the product, with water that was removed from the alcoholic solution (e.g., beverage) and separated from alcohol therein. The water may be WFW, water from a juice (e.g., grape juice), water from beer, or water from spirits.

Adding water to the alcoholic solution prior to the at least one of the plurality of FO processes may include injecting water into a concentrated alcoholic solution (e.g., concentrated alcoholic beverage output from a previous FO process). The water may be added to the product via water input streams, prior to, during, or after an FO process, such into a concentrated alcoholic solution as after an FO process but prior to a subsequent FO process. In some examples, adding water may only be performed after the first and second FO processes.

The act 620 of outputting the product as a final product may include outputting a concentrated dealcoholized solution (e.g., concentrated dealcoholized beverage) or a diluted and dealcoholized solution (e.g., diluted and dealcoholized beverage). For example, alcohol free or reduced alcohol wine or beer, or concentrates thereof, may be output as the final product. The alcohol content of the products of the FO processes after the first FO process, such as the final product, may be 5% ABW or less, such as 1.0% ABW or less, 0.5% ABW or less, 0.05% ABW or less, 0.01% ABW to 5% ABW, or 0.01% ABW to 0.5% ABW. The alcohol content of the products of the FO processes after the first FO process, such as the final product, may be 3 times less than the alcohol content of the initial feed stream (e.g., alcoholic beverage), such as 3 times to 50 times less, 3 times to 10 times less, or more than 10 times less than the initial alcohol content of the feed stream.

Outputting the product as the final product may include outputting the final product to a storage reservoir, such as one or more tanks, vats, trucks, bottles, barrels, or the like.

One or more portions of the method 600 may be automatically performed by a controller having machine readable and executable instructions for performing any of the portions of the method 600 stored on a tangible memory storage medium and executable by a processor associated therewith.

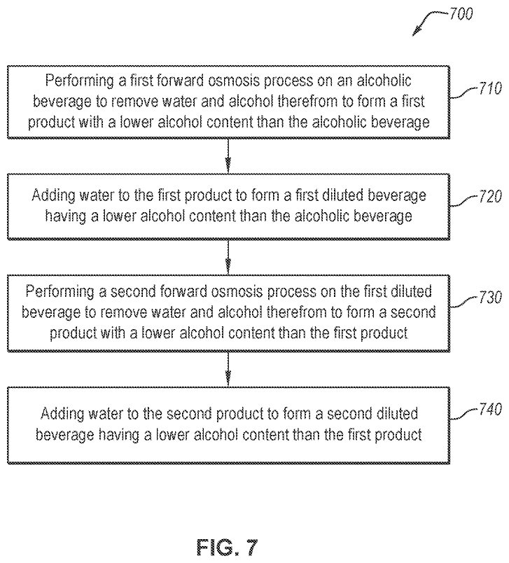

FIG. 7 is a flow diagram of a method 700 for removing alcohol from an alcoholic beverage, according to an embodiment. The method 700 includes an act 710 of performing a first FO process on an alcoholic beverage to remove water and alcohol therefrom to form a first product with a lower alcohol content than the alcoholic beverage, an act 720 of adding water to the first product to form a first diluted beverage having a lower alcohol content than the alcoholic beverage, an act 730 of performing a second FO process on the first diluted beverage to remove water and alcohol therefrom to form a second product with a lower alcohol content than the first product, and an act 740 of adding water to the second product to form a second diluted beverage having a lower alcohol content than the first product. The method 600 may include more or fewer acts than the acts 610 and 620. For example, one or more of the acts 610 or 620 may be split into more acts, omitted, or combined. Additional acts may be utilized as well.

The act 710 of performing a first FO process on an alcoholic beverage to remove water and alcohol therefrom to form a first product with a lower alcohol content than the alcoholic beverage includes circulating the alcoholic beverage through a first FO stage or module(s). The alcoholic beverage may include wine, beer, hard cider, or spirits having an initial alcohol content above 0.05 ABW. The FO stage or module(s) may include any of the FO modules or FO stages disclosed herein. The first FO process may include circulating or recirculating the alcoholic beverage through an FO stage or module (e.g., array) a selected number of times, such as 1 to 10,000 times, 1 to 100 times, 100 times to 1000 times, or less than 10,000 times. The first FO process may include circulating or recirculating the alcoholic beverage through an FO stage or module (e.g., array) for a selected duration, such as 1 minute or more, 1 minute to 100 hours, 1 minute to 1 hour, 1 hour to 10 hours, 5 hours to 20 hours, 10 hours to 20 hours, 1 hour to 1 day, 1 day to 7 days, 1 day to 3 days, 2 days to 5 days, or less than 7 days.

Performing a first FO process on an alcoholic beverage to remove water and alcohol therefrom to form a first product with a lower alcohol content than the alcoholic beverage includes circulating a draw stream having a lower osmotic potential than the alcoholic beverage through draw side of the first FO stage or module.

The act 720 of adding water to the first product to form a first diluted beverage having a lower alcohol content than the alcoholic beverage may include adding the amount of water removed from the alcoholic beverage in the first FO process. The volume of alcohol removed may not be replaced by water. The water may include water recovered from the diluted draw stream, WFW, water from juice, or water from a similar or identical beverage. The water may be added in a batch configuration such as in a tank or reservoir containing the first product (e.g., concentrated alcohol solution), or may be injected into a recirculating first product at a constant rate (e.g., volume).

The act 730 performing a second FO process on the first diluted beverage to remove water and alcohol therefrom to form a second product with a lower alcohol content than the first product includes circulating the first diluted beverage through a second FO stage or module(s). The FO stage or module(s) may include any of the FO stages or modules disclosed herein. The second FO process may include circulating or recirculating the alcoholic beverage through an FO stage or module (e.g., array) a selected number of times, such as 1 to 10,000 times, 1 to 100 times, 100 times to 1000 times, or less than 10,000 times. The second FO process may include circulating or recirculating the (first diluted) alcoholic beverage through an FO stage or module (e.g., array) for a selected duration, such as 1 minute or more, 1 minute to 100 hours, 1 minute to 1 hour, 1 hour to 10 hours, 5 hours to 20 hours, 10 hours to 20 hours, 1 hour to 1 day, 1 day to 7 days, 1 day to 3 days, 2 days to 5 days, or less than 7 days.

Performing a second FO process on the first diluted beverage to remove water and alcohol therefrom to form a first product with a lower alcohol content than the alcoholic beverage includes circulating a draw stream having a lower osmotic potential than the first diluted beverage through draw side of the second FO stage or module.

The act 740 adding water to the second product to form a second diluted beverage having a lower alcohol content than the first product may include adding the amount of water removed from the alcoholic beverage in the second FO process. The volume of alcohol removed may not be replaced by water. The water may include water recovered from the diluted draw stream, WFW, water from juice, or water from a similar or identical beverage. The water may be added in a batch configuration such as in a tank or reservoir containing the second product (e.g., concentrated alcohol solution), or may be injected into a recirculating second product at a constant rate (e.g., volume).

The second diluted beverage may be output as a final product having a lower alcohol content than the initial alcoholic beverage.

The method 700 may include performing a third FO process on the second diluted beverage to remove water and alcohol therefrom and form a third product with a lower alcohol content than the second product. Performing a third FO process on the second diluted beverage may be similar or identical to the act 730 in one or more aspects. For example, the FO stage or module(s) may include any of the FO stages or modules disclosed herein. The third FO process may include circulating or recirculating the alcoholic beverage through an FO stage or module(s) (e.g., array) a selected number of times, such as 1 to 10,000 times, 1 to 100 times, 100 times to 1000 times, or less than 10,000 times. The third FO process may include circulating or recirculating the (second diluted) alcoholic beverage through an FO stage or module(s) (e.g., array) for a selected duration, such as 1 minute or more, 1 minute to 100 hours, 1 minute to 1 hour, 1 hour to 10 hours, 5 hours to 20 hours, 10 hours to 20 hours, 1 hour to 1 day, 1 day to 7 days, 1 day to 3 days, 2 days to 5 days, or less than 7 days.

Performing the third FO process on the second diluted beverage to remove water and alcohol therefrom to form a second product with a lower alcohol content than the alcoholic beverage (and first product) includes circulating a draw stream having a lower osmotic potential than the second diluted beverage through draw side of the third FO stage or module(s).

The third product may have an alcohol content that is less than one half of the alcohol content of the initial alcoholic beverage, such as less than one eighth of the alcohol content of the alcoholic beverage, or less than one twenty fifth of the alcohol content of the alcoholic beverage.

The method 700 includes adding water to the third product. For example, adding water to the third product may include adding enough water to replace the amount of water removed from the original alcoholic beverage. The amount of alcohol removed may not be replaced by water. Adding water to the third product may be effective to form a third diluted beverage having an alcohol content of less than 5% ABW, less than 4% ABW, less than 1% ABW, less than 0.5% ABW, or less than 0.05% ABW.

The third diluted beverage may be output as a final product having a lower alcohol content than the initial alcoholic beverage.

The method 700 may further include performing a fourth FO process on the third diluted beverage to remove water and alcohol therefrom to form a fourth product with a lower alcohol content than the third product. Performing a fourth FO process may be similar or identical to performing the second or third FO process, in one or more aspects.

The method 700 may further include adding water to the fourth product to form a fourth diluted beverage having a lower alcohol content than the third product. For example, adding water to the fourth product may include adding enough water to replace the amount of water removed from the original alcoholic beverage. The amount of alcohol removed may not be replaced by water. Adding water to the fourth product may be effective to form the fourth diluted beverage having an alcohol content of less than 5% ABW, less than 4% ABW, less than 1% ABW, less than 0.5% ABW, or less than 0.05% ABW.

The fourth diluted beverage may be output as a final product having a lower alcohol content than the initial alcoholic beverage.

The method 700 may further include performing a fifth FO process on the fourth diluted beverage to remove water and alcohol therefrom to form a fifth product with a lower alcohol content than the fourth product. Performing the fifth FO process may be similar or identical to performing the second, third, or fourth FO process, in one or more aspects.

The method 700 may include adding water to the fifth product to form a fifth diluted beverage having a lower alcohol content than the fourth product. For example. adding water to the fifth product may include adding enough water to replace the amount of water removed from the original alcoholic beverage. The amount of alcohol removed may not be replaced by water. Adding water to the fifth product may be effective to form the fifth diluted beverage having an alcohol content of less than 5% ABW, less than 4% ABW, less than 1% ABW, less than 0.5% ABW, or less than 0.05% ABW.

The fifth diluted beverage may be output as a final product having a lower alcohol content than the initial alcoholic beverage.

The method 700 may include performing a sixth FO process on the fifth diluted beverage to remove water and alcohol therefrom to form a sixth product with a lower alcohol content than the fifth product. Performing the sixth FO process may be similar or identical to performing the second, third, fourth, or fifth FO process, in one or more aspects. The sixth product may have an alcohol content that is less than one twenty fifth of the alcohol content of the alcoholic beverage or less than one hundredth of the alcohol content of the alcoholic beverage.

The method 700 may include adding water to the sixth product to form a sixth diluted beverage having a lower alcohol content than the fifth product. For example, adding water to the sixth product may include adding enough water to replace the amount of water removed from the original alcoholic beverage. The amount of alcohol removed may not be replaced by water. Adding water to the sixth product may be effective to form the sixth diluted beverage having an alcohol content of less than 5% ABW, less than 4% ABW, less than 1% ABW, less than 0.5% ABW, or less than 0.05% ABW. The sixth diluted beverage may be output as a final product having a lower alcohol content than the initial alcoholic beverage.

Performing a first forward osmosis process, a second forward osmosis process, a third forward osmosis process, a fourth forward osmosis process, a fifth forward osmosis process, and a sixth forward osmosis process may include forming a diluted draw solution having water and alcohol therein. The method 700 may further include separating the alcohol removed from the alcoholic beverage from the diluted draw solution (e.g., stream) to at least partially form a draw solution (e.g., draw stream). Separating the alcohol from the diluted draw stream may include one or more of RO, steam stripping, or distillation. The alcohol may be separated from the draw solutes as well as the water of the draw stream and water removed from the alcoholic beverage using one or more of the above techniques. The water content of the draw stream may be restored to a pre FO process amount and the alcohol may be substantially completely removed from the diluted draw stream.

Any number of additional FO processes and corresponding water additions may be included in the method 700. The FO stage(s) or module(s) used in the method 700 may include any of the FO stages or modules disclosed herein.

In some embodiments, a method of removing alcohol from an alcoholic solution includes recirculating an alcoholic solution through a single FO module or array multiple times (e.g., 10-10,000 times) to concentrate the alcoholic solution and then water may be added to the recirculating alcoholic solution when a selected concentration factor is reached. The water may be added at a rate selected to maintain the volume of water in the recirculating alcoholic solution to the volume of water present in the initial alcoholic solution. The volume of removed alcohol is not replaced by water. The recirculating alcoholic solution has more alcohol removed as the water is replaced, thereby providing increased alcohol removal compared to static alcoholic solutions (e.g., no water added). Such methods may be sensor based (e.g., based on volume detected by a flow meter, weight of alcoholic solution in a feed tank, or concentration detected by one or more sensors). In some examples, the system 100, 200, 300, 400, or 500 may be utilized to perform the alcohol removal.

The methods disclosed herein can be used to remove alcohol from any alcoholic solution, not just alcoholic beverages.

### WORKING EXAMPLES

Experimental runs of alcoholic solution concentrations were performed on alcoholic beverages to determine a mathematical model of the flux rates and concentration factors of feed stream and draw stream components in the processes disclosed herein. The mathematical model was used to model working examples of various configurations for systems and processes.

Working Example 1 included a starting alcoholic solution of 10,000 kg of wine having 11.25% ABW (e.g., 14% ABV) and an initial concentration factor of 1. The wine was circulated through the feed side of an FO system, having an FO stage including three FO modules operably coupled together in series and each comprising an FO membrane including a polyamide rejection layer on a support layer and through which water and ethanol are permeable and larger components are impermeable, for 3-4 days. The total FO membrane area was 147 m². Water addition to make up lost water from the wine started after 15 hours. The wine was circulated through the FO stage for the remainder of the 3-4 days (e.g., equivalent of about 2 more concentration stages). Processing the wine in the FO system formed 2,000 kg of a concentrated and dealcoholized wine solution with 1.75% ABW and a concentration factor of the well rejected components of wine of 4.5 times the original concentration. The draw stream included water and glycerol (28% by weight of the draw stream) prior to dilution with alcohol and water from the wine. The water and alcohol absorbed from the wine is separated from the diluted draw stream to form a regenerated draw stream, water from wine (e.g., water having no alcohol therein), and a waste stream of water and alcohol (5% ABW).

The concentrated and dealcoholized wine was combined with 6,900 kg of water from wine to form 8,900 kg of diluted and dealcoholized wine (product) having less than 0.4% ABW (e.g., less than 0.5% ABV) and a concentration factor of the well rejected components of 1. In Working Example 1, about 1,100 kg of alcohol is removed from the initial wine.

Working Example 2 includes a starting alcoholic solution of 1,000 kg of wine having 14% ABV and an initial concentration factor of 1. The wine was circulated through the feed side of an FO system at a rate of 1000 kg/hour, the FO system included six FO stages, variously including two to six FO modules in each stage (21 total FO modules and a total membrane area of 1,323 m²) each module having an FO membrane including a polyamide rejection layer on a support layer and through which water and ethanol are permeable and larger components are impermeable and a membrane area of 63 m². The FO system was designed for continuous processing and included a first FO stage for concentration and at least one water addition point followed by an additional FO stage for concentration. The additional FO stage can include one of recycling to the first FO stage or an identical second FO stage. Processing the wine in the FO system formed 250 kg/h of a concentrated and dealcoholized wine solution with less than 0.2% ABV and a concentration factor of the well rejected components of wine of 4 times the original concentration. The draw stream included water and glycerol (28% by weight of the draw stream) prior to dilution with alcohol and water from the wine. The water and alcohol absorbed from the wine is separated from the diluted draw stream to form a regenerated draw stream, water from wine (e.g., water having no alcohol therein), and a waste stream of water and alcohol (5% ABW).

The concentrated and dealcoholized wine was combined with 638 kg/h of water from wine to form 880 kg/hr of diluted and dealcoholized wine (product) having less than 0.05% ABW (e.g., less than 0.05% ABV) and a concentration factor of the well rejected components of about 1. In Working Example 2, about 120 kg of alcohol is removed from the initial wine every hour.

Working Example 3 included a three module FO system that processed wine in multiple stages. In the first stage, a starting alcoholic solution of 5,000 kg of wine having 11.66% ABW (e.g., 14.5% ABV) and an initial concentration factor of 1. The wine was circulated through the feed side of an FO system, having an FO stage with three FO modules operably coupled together in series and each comprising an FO membrane module having an FO membrane comprising a polyamide rejection layer on a support layer and through which water and ethanol are permeable and larger components are impermeable, for about 15 hours. The total membrane area was 147 m². Each of the three FO modules in the FO system included an FO module having seven PFO-100 membrane elements (available from PORIFERA INC. of San Leandro, California) arranged in series. Processing the wine in the FO system formed 1,429 kg of a concentrated and dealcoholized wine solution with 9.33% ABW and a concentration factor of the well rejected components of wine of 3.5 times the original concentration.

The draw stream included 2,500 kg of a solution having 28 wt % glycerol by weight prior to dilution with alcohol and water from the wine. The diluted draw stream was 6,071 kg, had 7.4% ABW, and a glycerol concentration of 11.5% by weight. The water and alcohol absorbed from the wine was separated from the diluted draw stream to form a regenerated draw stream, water from wine (e.g., water having no alcohol therein), and a waste stream of water and alcohol. 5,627 kg of steam was used to steam strip the diluted draw stream to form 6,078 kg of waste alcohol stream having 7.4% ABW (recovered from the steam condensate) and 5,621 kg of partially regenerated draw stream having 12.45% glycerol by weight. The partially regenerated draw stream is further processed in an RO module for 5 hours to remove 3.122 kg of water therefrom to reform 2,500 kg of draw stream having 28% glycerol by weight.

The concentrated and dealcoholized wine was combined with 3,122 kg of water from wine to form 4,571 kg of diluted and dealcoholized wine (first product) having 2.93%

ABW and a concentration factor of the well rejected components of about 1. In the first stage, about 429 kg of alcohol is removed from the initial wine.

In the second stage, the first product solution of 4,571 kg of wine having 2.93% ABW was recirculated through the feed side of the FO system, for about 11 hours. Processing the first product in the FO system formed 1,300 kg of a second concentrated and dealcoholized wine solution with 2.34% ABW and a concentration factor of the well rejected components of wine of 3.5 times the original concentration.

The second draw stream included 2.500 kg of a solution having 28 wt % glycerol by weight prior to dilution with alcohol and water from the wine. The second diluted draw stream was 5,750 kg, had 1.8% ABW, and a glycerol concentration of 12.17% by weight. The water and alcohol absorbed from the wine was separated from the second diluted draw stream to form a regenerated draw stream, water from wine (e.g., water having no alcohol therein), and a waste stream of water and alcohol. 2,467 kg of steam was used to steam strip the second diluted draw stream to form 2,570 kg of waste alcohol stream having 4% ABW (recovered from the steam condensate) and 5,047 kg of partially regenerated draw stream having 12.4% glycerol by weight. The second partially regenerated draw stream is further processed in the RO module for 5 hours to remove 3,147 kg of water therefrom to reform some of the draw stream having 28% glycerol by weight.

The 1,300 kg of the second concentrated and dealcoholized wine was combined with 3147 kg of water from wine to form 4.447 kg of diluted and dealcoholized wine (second product) having 0.68% ABW and a concentration factor of the well rejected components of about 1. In the second stage, about 124 kg of alcohol is removed from the wine.

In the third stage, the second product solution of 4,447 kg of wine having 0.68% ABW was recirculated through the feed side of the FO system, for about 9 hours. Processing the second product in the FO system formed 1,271 kg of a third concentrated and dealcoholized wine solution with 0.55% ABW and a concentration factor of the well rejected components of wine of 3.5 times the original concentration.

The third draw stream included 2,500 kg of a solution having 28 wt % glycerol by weight prior to dilution with alcohol and water from the wine. The third diluted draw stream was 5,677 kg, had 0.41% ABW, and a glycerol concentration of 12.3% by weight. The water and alcohol absorbed from the wine was separated from the third diluted draw stream to form a regenerated draw stream, water from wine (e.g., water having no alcohol therein), and a waste stream of water and alcohol. 564 kg of steam was used to steam strip the third diluted draw stream to form 587 kg of waste alcohol stream having 4% ABW (recovered from the steam condensate) and 5,654 kg of third partially regenerated draw stream having 12.4% glycerol by weight. The third partially regenerated draw stream is further processed in the RO module for about 5 hours to remove 3,153 kg of water therefrom to reform some of the draw stream having 28% glycerol by weight.

The 1,271 kg of the third concentrated and dealcoholized wine was combined with 3,153 kg of water from wine to form 4,424 kg of diluted and dealcoholized wine (third product) having 0.16% ABW and a concentration factor of the well rejected components of about 1. In the third stage, about 23 kg of alcohol is removed from the wine.

In the fourth stage, the third product solution of 4,424 kg of wine having 0.16% ABW was recirculated through the feed side of the FO system, for about 9 hours. Processing the third product in the FO system formed 1,264 kg of a fourth concentrated and dealcoholized wine solution with 0.13% ABW and a concentration factor of the well rejected components of wine of 3.5 times the original concentration.

The fourth draw stream included 2,500 kg of a solution having 28 wt % glycerol by weight prior to dilution with alcohol and water from the wine. The fourth diluted draw stream was 5,660 kg, had 0.09% ABW, and a glycerol concentration of 12.4% by weight. The water and alcohol absorbed from the wine was separated from the fourth diluted draw stream to form a regenerated draw stream, water from wine (e.g., water having no alcohol therein), and a waste stream of water and alcohol. 532 kg of steam was used to steam strip the fourth diluted draw stream to form 537 kg of waste alcohol stream having 1% ABW (recovered from the steam condensate) and 5,654 kg of fourth partially regenerated draw stream having 12.4% glycerol by weight. The fourth partially regenerated draw stream is further processed in the RO module for about 5 hours to remove 3,160 kg of water therefrom to reform some of the draw stream having 28% glycerol by weight.

The 1,264 kg of the fourth concentrated and dealcoholized wine was combined with 3,160 kg of water from wine to form 4,424 kg of diluted and dealcoholized wine (fourth product) having 0.036% ABW and a concentration factor of the well rejected components of about 1. In the fourth stage, about 7 kg of alcohol is removed from the wine.

While 1 to 4 stages are described for the working examples herein, more than 1 or 4 FO stages may be utilized to remove alcohol from an alcoholic solution using diafiltration after initially concentrating the solution.

The systems and methods disclosed herein allow for the efficient removal of alcohol from alcoholic beverages without altering the flavor of the beverage. For example, thermal manipulation of the alcoholic beverage may be avoided to remove the alcohol by utilizing forward osmosis a diafiltration. It was surprisingly found that during the dilution and concentration steps the osmotic pressure of the wine drops as it concentrates, thereby allowing for continued and greater solvent removal.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for removing alcohol from a beverage, the method comprising:
performing a plurality of forward osmosis processes on an alcoholic beverage to remove alcohol therefrom effective to form a product with a lower alcohol content than the alcoholic beverage, wherein each of the plurality of forward osmosis processes removes water and at least some alcohol from the alcoholic beverage and at least one of the plurality of forward osmosis processes after an initial forward osmosis process includes adding water to the alcoholic beverage prior to the at least one of the plurality of forward osmosis processes; and
outputting the product as a final product.

2. The method of claim 1 wherein performing a plurality of forward osmosis processes on an alcoholic beverage to remove alcohol therefrom includes:
circulating a feed solution through a feed side of a forward osmosis module; and
circulating a draw solution having a lower alcohol content than one or more of the alcoholic beverage or product through a draw side of a forward osmosis module corresponding to a specific forward osmosis process.

3. The method of claim 1 wherein adding water to the alcoholic beverage includes adding water to the product that was removed from the alcoholic beverage and separated from alcohol therein.

4. The method of claim 1 wherein performing a plurality of forward osmosis processes on an alcoholic beverage to remove alcohol therefrom includes forming a diluted draw stream containing alcohol removed from the alcoholic beverage; and
the method further comprises separating the alcohol removed from the alcoholic beverage from the diluted draw stream via one or more of steam stripping or distilling the diluted draw stream to at least partially reform the draw solution.

5. (canceled)

6. (canceled)

7. The method of claim 1 wherein performing a plurality of forward osmosis processes on an alcoholic beverage to remove alcohol therefrom includes:
performing a first forward osmosis process on an alcoholic beverage to remove alcohol and water therefrom to form a first product;
adding water to the first product to form a first diluted beverage having a lower alcohol content than the alcoholic beverage;
performing a second forward osmosis process on the first diluted beverage to remove alcohol and water therefrom to form a second product; and
adding water to the second product to form a second diluted beverage having a lower alcohol content than the first product.

8. The method of claim 7 wherein performing a plurality of forward osmosis processes on an alcoholic beverage to remove alcohol therefrom includes:
performing a third forward osmosis process on the second diluted beverage to remove alcohol therefrom and form a third product with a lower alcohol content than the second product;
adding water to the third product to form a third diluted beverage having a lower alcohol content than the second product; and
performing a fourth forward osmosis process on the third diluted beverage to remove alcohol therefrom and form a fourth product with a lower alcohol content than the third product.

9. The method of claim 1 wherein the final product includes an alcohol content of 0.5 alcohol by weight or less.

10. The method of claim 1 wherein the alcoholic beverage includes wine or beer.

11. (canceled)

12. The method of claim 1, wherein performing a plurality of forward osmosis processes on an alcoholic beverage to remove alcohol therefrom includes recirculating the product through a single forward osmosis stage to perform each forward osmosis process.

13. A system for removing alcohol from alcoholic solutions, the system comprising:
a first forward osmosis stage configured to receive an alcoholic solution having a concentrated feed stream output and a diluted draw stream output;
a water input operably coupled to the concentrated feed stream output to add water thereto to form a first diluted feed stream; and
at least a second forward osmosis stage operably coupled to the first forward osmosis stage to receive the first diluted feed stream and output a product having an alcohol concentration that is less than an alcohol concentration of the alcoholic solution.

14. The system of claim 13 wherein the at least a second forward osmosis stage includes:
a second forward osmosis stage; and
a third forward osmosis stage;
wherein the first, second, and third forward osmosis stages each have a feed side and a draw side separated by a forward osmosis membrane, the feed side including a feed inlet and the concentrated feed stream output; and
wherein the concentrated feed stream output of the first forward osmosis stage is connected to the feed inlet of the second forward osmosis stage and the concentrated feed stream output of the second forward osmosis stage is connected to the feed inlet of the third forward osmosis stage.

15. The system of claim 13, further comprising an additional water input operably coupled to the concentrated feed stream output of the second forward osmosis stage.

16. The system of claim 13, further comprising at least one draw stream regeneration apparatus operably connected to a draw side outlet of one or more of the first forward osmosis stage or the at least a second forward osmosis stage to receive diluted draw solution therefrom, wherein the at least one draw stream regeneration apparatus is configured to remove one or both of water or alcohol from the diluted draw solution and includes one or more of a distillation apparatus, a steam stripper, or at least one reverse osmosis stage.

17. (canceled)

18. (canceled)

19. (canceled)

20. A method for removing alcohol from a beverage, the method comprising:
performing a first forward osmosis process on an alcoholic beverage to remove water and alcohol therefrom to form a first product with a lower alcohol content than the alcoholic beverage;
adding water to the first product to form a first diluted beverage having a lower alcohol content than the alcoholic beverage;
performing a second forward osmosis process on the first diluted beverage to remove water and alcohol therefrom to form a second product with a lower alcohol content than the first product; and
adding water to the second product to form a second diluted beverage having a lower alcohol content than the first product.

21. The method of claim 20 further comprising performing a third forward osmosis process on the second diluted beverage to remove water and alcohol therefrom to form a third product with a lower alcohol content than the second product.

22. The method of claim 21 wherein the third product has an alcohol content that is less than one half of the alcohol content of the alcoholic beverage, less than one eighth of the alcohol content of the alcoholic beverage, or less than one twenty fifth of the alcohol content of the alcoholic beverage.

23. The method of claim 21, further comprising adding water to the third product to form a third diluted beverage having an alcohol content of less than 5% alcohol by weight, less than 4% alcohol by weight, less than 1% alcohol by weight, less than 0.5% alcohol by weight, or less than 0.05% alcohol by weight.

24. The method of claim 21, further comprising:
adding water to the third product to form a third diluted beverage having a lower alcohol content than the second product; and
performing a fourth forward osmosis process on the third diluted beverage to remove water and alcohol therefrom to form a fourth product with a lower alcohol content than the third product;
adding water to the fourth product to form a fourth diluted beverage having a lower alcohol content than the third product; and
performing a fifth forward osmosis process on the fourth diluted beverage to remove water and alcohol therefrom to form a fifth product with a lower alcohol content than the fourth product;
adding water to the fifth product to form a fifth diluted beverage having a lower alcohol content than the fourth product; and
performing a sixth forward osmosis process on the fifth diluted beverage to remove water and alcohol therefrom to form a sixth product with a lower alcohol content than the fifth product.

25. The method of claim 24 wherein the sixth product has an alcohol content that is less than one twenty fifth of the alcohol content of the alcoholic beverage or less than one hundredth of the alcohol content of the alcoholic beverage.

26. The method of claim 24, further comprising adding water to the sixth product to form a sixth diluted beverage having an alcohol content of less than less than 1% alcohol by weight, less than 0.5% alcohol by weight, or less than 0.05% alcohol by weight.

27. (canceled)

28. (canceled)

29. (canceled)

30. (canceled)
